(19) United States
(12) Patent Application Publication
(10) Pub. No.: US 2012/0116694 A1
(43) Pub. Date: May 10, 2012

(54) Method and Apparatus for Tire Pressure Monitoring

(76) Inventor: John Peter Norair, San Francisco, CA (US)

(21) Appl. No.: 13/289,050

(22) Filed: Nov. 4, 2011

Related U.S. Application Data
(60) Provisional application No. 61/456,232, filed on Nov. 4, 2010.

(51) Int. Cl. G06F 19/00

(52) U.S. Cl. 702/50

(57) ABSTRACT

A tire pressure monitoring system comprising a sensor located inside a tire of a vehicle may be operable to measure one or both of a temperature inside the tire, and flexion of the tire. The tire pressure monitoring system may be operable to calculate an air pressure inside the tire based on one or both of the measured temperature and the measured flexion. Communications between the sensor and other components of the tire pressure monitoring system may be wireless, such as, for example, via an ISO 18000-7 link. The sensor may be embedded in the tire (e.g., in the sidewall, in the tread, or in the liner). The sensor may measures flexion of the tire at a point (e.g., the point where the tire meets the ground) where the tire is being compressed and at a point (e.g., the point opposite where the tire meets the ground) where the tire is not being compressed.

### CLAIM OF PRIORITY

This patent application makes reference to, claims priority to and claims benefit from U.S. Provisional Patent Application Ser. No. 61/456,232 filed on Nov. 4, 2010.

The above stated application is hereby incorporated herein by reference in its entirety.

### INCORPORATION BY REFERENCE

This patent application also makes reference to:

U.S. Provisional Patent Application Ser. No. 61/464,376 filed on Mar. 2, 2011.

Each of the above stated applications is hereby incorporated herein by reference in its entirety.

### FIELD OF THE INVENTION

Certain embodiments of the invention relate to automotive electronics. More specifically, certain embodiments of the invention relate to a method and apparatus for tire pressure monitoring.

### BACKGROUND OF THE INVENTION

Conventional tire pressure monitoring systems are expensive and difficult to implement. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

An apparatus and/or method is provided for tire pressure monitoring, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

FIG. 1A illustrates an electronic tire pressure monitoring system.

FIG. 1B illustrates exemplary circuitry for securing communications of an electronic tire pressure management system.

FIG. 2 depicts exemplary devices of an electronic tire pressure monitoring system.

FIG. 3 depicts an exemplary sensor located inside a tire, wherein the sensor is mounted to the tire.

FIG. 4A depicts an exemplary sensor located inside a tire, wherein the sensor is mounted to the tire.

FIG. 4B is a side-view of a wheel and tire illustrating various exemplary points at which tire flexion may be measured.

FIG. 4C is a cross-sectional view of a wheel and tire illustrating the measurement of tire flexion.

FIG. 5 depicts an exemplary sensor located inside a tire, wherein the sensor is embedded in the tire.

FIG. 6 is a flowchart illustrating exemplary steps for monitoring tire pressure via a temperature sensor located inside a tire.

FIG. 7 is a flowchart illustrating exemplary steps for monitoring tire pressure via a flexion sensor located inside a tire.

### DETAILED DESCRIPTION OF THE INVENTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be implemented in hardware, software, firmware, or any combination of one or more thereof. As utilized herein, the term “exemplary” means serving as a non-limiting example, instance, or illustration. As utilized herein, the terms “e.g.” and “for example” introduce a list of one or more non-limiting examples, instances, or illustrations.

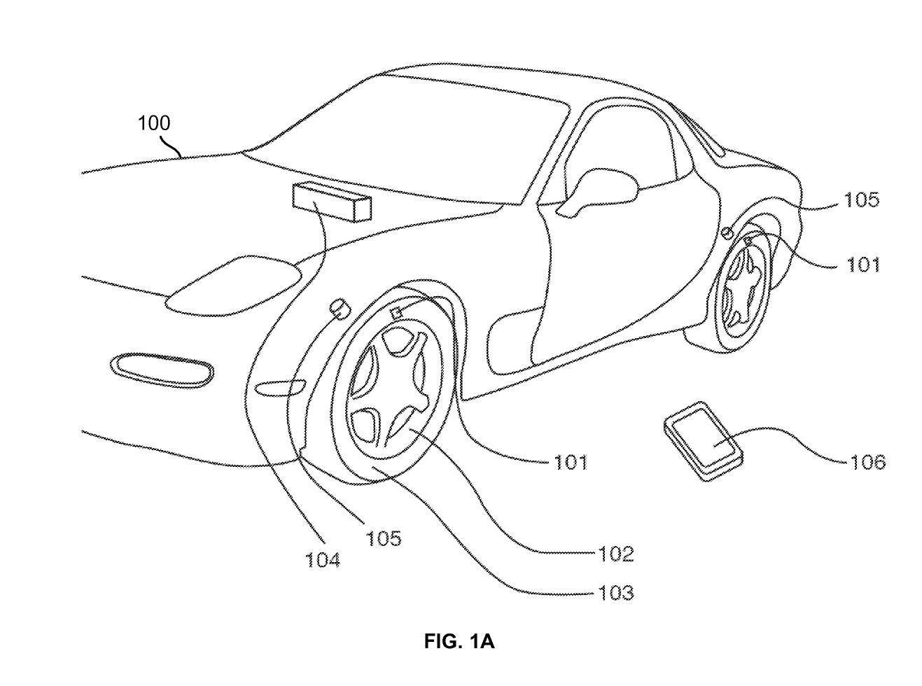

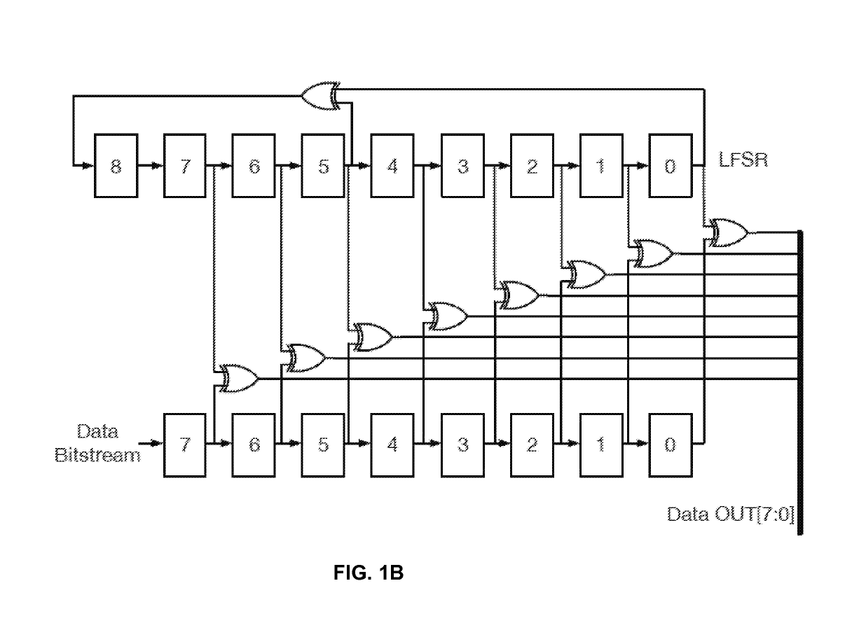

FIG. 1A illustrates an electronic tire pressure monitoring system. The tire pressure monitoring system of the vehicle 100 comprises a plurality of sensors 101, a plurality of exciters 105, an internal access point 104, and an external access point 106. Each of the sensors 101 is mounted in and/or on a tire 103 or a wheel 102.

Each of the sensors 101 comprises circuitry operable to make one or more measurements and communicate those measurements wirelessly. Each of the sensors may be operable to communicate with a corresponding one of the exciters 105 and/or with one or both of the access points 104 and 106. Each of the sensors 101 may be operable to communicate at one or more frequencies utilizing near-field and/or far-field communications. For example, each of the sensors 101 may be operable to communicate in accordance with the ISC 18000-7 standard and/or as described in above-incorporated U.S. Patent Application 61/464,376 entitled “Advanced Communication System for Wide-Area Low Power Wireless Applications and Active RFID.” Each of the sensors 101 may be operable to directly measure tire pressure and/or to measure one or more parameters (e.g., temperature and/or tire flexion) which may be utilized to calculate tire pressure.

Each of the exciters 105 may comprise circuitry operable to communicate with a corresponding one of the sensors 101. Each of the exciters may, for example, comprise a near-field transmitter which transmits at a signal strength that is strong enough only to reach the corresponding sensor 101 but not the other sensors 101.

The internal access point 104 may comprise circuitry operable to communicate with the sensors 101 and/or the exciters 105, to communicate with an on-board computing system of the vehicle 100, and to calculate tire pressure based on received measurements. The internal access point 104 may be operable to transmit and/or receive commands and/or responses to and/or from the exciters 105 and/or the sensors 101. For example, the internal access point 104 may be operable to communicate in accordance with the ISC 18000-7 standard and/or as described in above-incorporated U.S. Patent Application 61/464,376 entitled “Advanced Communication System for Wide-Area Low Power Wireless Applications and Active RFID.”

The external access point 106 may comprise circuitry operable to communicate with the sensors 101 and/or the exciters 105, to communicate with an on-board computing system of the vehicle 100, and to calculate tire pressure based on received measurements. The external access point 106 may be operable to transmit and/or receive commands and/or responses to and/or from the exciters 105 and/or the sensors 101. For example, the internal access point 104 may be operable to communicate in accordance with the ISC 18000-7 standard and/or as described in above-incorporated U.S. Patent Application 61/464,376 entitled “Advanced Communication System for Wide-Area Low Power Wireless Applications and Active RFID.”

In operation, the exciters 105 may excite their respective sensors 101 and the sensors 101 may transmit measurements. The measurements may be received by the internal access point 104. In instances that the received measurements are direct pressure measurements, the access point 104 may relay those measurements to an on-board computer for presentation on an in-car display. In instances that the received measurements are indirect measurements of pressure (e.g., temperature and/or flexion) the internal access point 104 may utilize the received measurements to calculate the tire pressure, and then relay the tire pressure to the on-board computer for display.

Similarly, the external access point 106 may receive measurements from the sensors 101, calculate tire pressure in instances that the measurements are not direct pressure measurements, and display the tire pressure on a screen of the external access point 106. The external access point 106 may, for example, be utilized by service technicians during installation and/or maintenance.

Communications to and/or from the wireless sensors 101 may be addressed and/or encrypted. In an embodiment of the invention, each sensor 101 may comprise a unique identifier (e.g., a number “burned it” during manufacturing) which may be utilized as, or in generating, an address for the sensor 101. This may reduce the possibility of confusing measurements from different sensors and/or to reduce the likelihood of erroneous tire pressure readings. The address may be encoded by, for example, scrambling it utilizing a key that periodically or occasionally changes so as to reduce the risk of a malicious attack such as a replay or man-in-the-middle attack.

In an embodiment of the invention, packets communicated to and/or from the sensors 101 may comprise a header, an addressing template, and packet data. The link over which the packets are transmitted may be secured utilizing a lightweight, symmetric-key cryptographic algorithm, such as AES 128. In an embodiment of the invention, the data payload may be encrypted according to the rules of the algorithm, but the header and addressing template may be unencrypted. This may allow the system to maintain numerous encryption strategies, and to select different key sequences for each sensor 101.

In an exemplary embodiment of the invention, an exemplary key sequence includes a base key value (K), a key transformation value (T), and an iterator value (i). The key that is used to encrypt data is a product of the base key value, the key transformation value, and the iterator value. The transformation value feeds into a PN9 sequence as follows: (1) The linear feedback shift register (LFSR) is initialized to the specified polynomial; (2) Data is shifted in bit-by-bit while the LFSR shifts at the same rate; (3) an XOR operation is latched to Data Out when a full byte of data has been shifted in. Encoding and decoding may follow this process symmetrically. Encoding/decoding may use a table of precompiled LFSR values. The iterator value may indicate the number of loops in which the transformation value is processed by the PN9 sequence. This resultant value, T′, is XOR'ed with K to yield K′. K′ is the key that is used to encrypt data. The values for K, T, and i, are provided at initialization of the key sequence. This rotating key methodology may be used due to the fact that the transmissions from the Wireless Sensors tend to be repetitive, so the system is vulnerable to replay attacks, even if the encrypted data itself is not understood by the malicious third party. Using a continually morphing key prevents the encrypted data from being repetitive, even if the underlying data is indeed repetitive.

In an embodiment of the invention, each sensor 101 may have a physical reset button, or other type of physical interface element, that allows a user to reset the secure key. This interface element may be positioned on the sensor 101 such that it is accessible only inside the tire. Once a sensor 101 is reset, it may accept a new key, sent in an unencrypted channel, via a corresponding exciter 105. The key may be made known to the access point 104 as well. Accordingly, all subsequent, data-bearing communications between the sensor 101 and the exciter 105 and/or access point 104 may be encrypted using this key.

In an embodiment of the invention, the exciters 105, the internal access point 104, and/or the external access point 106 may maintain a list of keys that are linked to addresses of the sensors 101. In this manner, a different key may be used for each sensor 101. Alternatively, a single key be used for all of the sensors 101 of the vehicle 100.

In some instances, new key sequences may be transmitted as part of a re-initialization request to the sensors 101. In such an instance, the re-initialization request may include a new key sequence and may be encrypted with the existing key. Following any response to this re-initialization request, subsequent communications, may use the new key sequence. Re-initialization of keys may be handled by an exciter 105, by the internal access point 104, and/or by the external access point 106.

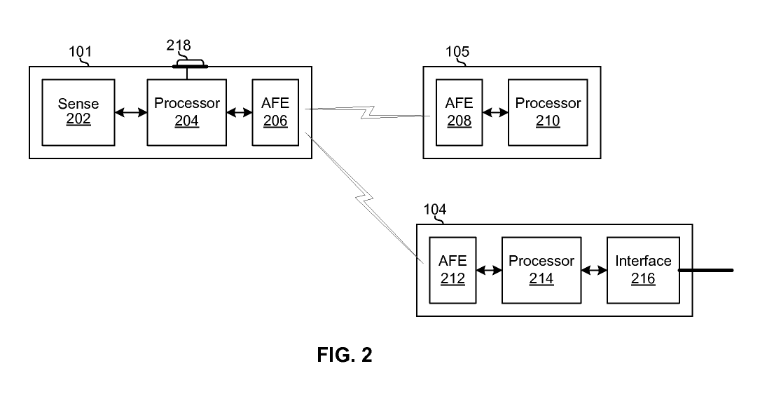

FIG. 2 depicts exemplary devices of an electronic tire pressure monitoring system. Shown in FIG. 2 are an exemplary sensor 101, an exemplary exciter 105, and an exemplary access point 104.

The sensor 101 may comprise a sense module 202, a reset button 218, a processor 204, and an analog front end (AFE) 206. The sense module 202 may be operable to measure one or more parameters. For example, in various embodiments of the invention, the sense module 202 may be operable to directly measure air pressure, to measure temperature, and/or to measure tire flexion. The processor 204 may be operable receive measurements from the sense module 202, format and/or otherwise process the measurements according to wireless protocols being used, and convey the measurements to the AFE 206 for transmission. The processor 204 may also be operable to receive data (e.g., commands transmitted by the exciter 105 and/or access point 104) via the AFE 206, and act and/or respond accordingly. The AFE 206 may be operable to modulate data received from the processor 204 onto an RF carrier and transmit the resulting signal. The AFE 206 may be operable to demodulate a received signal and convey the resulting baseband signal to the processor 204. In various embodiments of the invention, the AFE 206 may support near-field and/or far-field (e.g., ISO 18000-7) communications. The reset button 218 may initialize the processor 204 and/or the sense module 202 to a known state (e.g., to a state in which baseline parameters are stored and the sensor 101 is ready to exchange security keys as described above with respect to FIG. 1B).

The exciter 105 may comprise a processor 210 and an AFE 208. The processor 204 may be operable generate messages formatted according to wireless protocols being used, and convey the messages to the AFE 208 for transmission. The processor 210 may also be operable to receive data (e.g., commands and/or responses transmitted by the sensor 101 and/or the access point 104) via the AFE 208, and act and/or respond accordingly. The AFE 208 may be operable to modulate data received from the processor 210 onto an RF carrier and transmit the resulting signal. The AFE 208 may be operable to demodulate a received signal and convey the resulting baseband signal to the processor 210. In various embodiments of the invention, the AFE 208 may support near-field and/or far-field (e.g., ISO 18000-7) communications.

The access point 104 may comprise a processor 214, an AFE 212, and an interface 216. The processor 214 may be operable to generate messages formatted according to wireless protocols in use, and convey the messages to the AFE 212 for transmission. The processor 214 may also be operable to receive data (e.g., commands and/or responses transmitted by the sensor 101 and/or the exciter 105) via the AFE 212, and act and/or respond accordingly. The AFE 212 may be operable to modulate data received from the processor 214 onto an RF carrier and transmit the resulting signal. The AFE 212 may be operable to demodulate a received signal and convey the resulting baseband signal to the processor 214. In various embodiments of the invention, the AFE 212 may support near-field and/or far-field (e.g., ISO 18000-7) communications. The interface 216 may be operable to exchange messages with an on-board computer of the vehicle 100. The processor 214 may also be operable to generate messages formatted for communication to the on-board computer via the interface 216, and convey the messages to the AFE 212 for transmission.

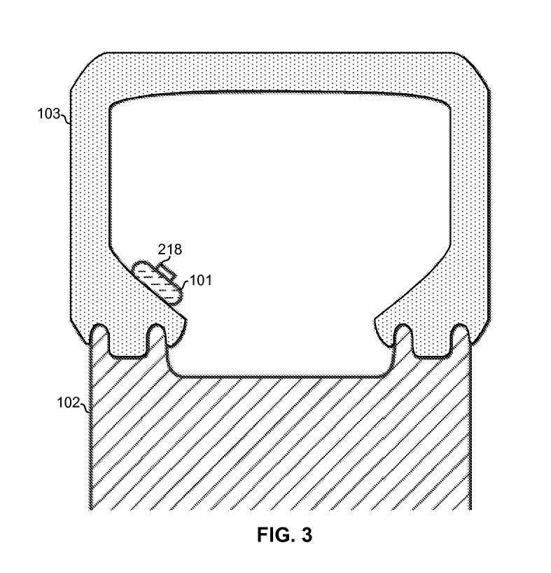

FIG. 3 depicts an exemplary sensor located inside a tire, wherein the sensor is mounted to the tire. Shown in FIG. 3 is a cross-section of a tire 103 and a wheel 102 with a sensor 101 mounted to the inside of the tire 103. The sensor 101 may be as described above with respect to FIG. 2. The sensor 101 depicted in FIG. 3 may be operable to make temperature measurements from which tire pressure may be calculated.

Measuring temperature instead of directly measuring pressure may be advantageous because a temperature sense module may be smaller and cheaper than a sense module that directly measures air pressure. A smaller, cheaper sensor may, for example, allow embedding the sensor into the tire itself and may reduce the contribution of the sensor 101 to tire imbalance.

The temperature measurements may be utilized to calculate tier pressure according to the Ideal Gas Law, which correlates temperature and pressure through the following relationship: p/n=RT/V. The value for ‘R’ is a constant, and the value for V can be assumed to be constant for the tire pressure application since only in extreme conditions will the volume of the tire degrade appreciably (i.e., conditions where the pressure is so low that it is visibly obvious). Therefore, the relationship between the temperature inside the tire can be derived from the temperature, ‘T’, and the value ‘n’, a measurement of the amount of molecules of gas inside the tire. The temperature of the tire, and the gas inside, is also dependent on the heat created by friction as the tire makes contact with the road, and the outside temperature. However, various parameters, such as the history of the vehicle's speed, travel time, and outside temperature, can be utilized to compensate for this effect. These and other parameters may be measured by the sensor 101 and/or other sensors of the vehicle 100 and conveyed to the access point 104 such that the access point 104 can utilize parameters in calculating the tire pressure based on the temperature readings from the sensor 101. In an embodiment of the invention, absolute values of p and n themselves may be measured empirically in relation to temperature, prior to deployment of the Wireless Sensor in a given tire. Upon proper inflation of a tire, the system may be reset to establish baseline values. Accordingly, in this exemplary embodiment, the purpose is not to measure the pressure of the tire directly, but instead to compare the current state of the tire with a known, properly inflated state.

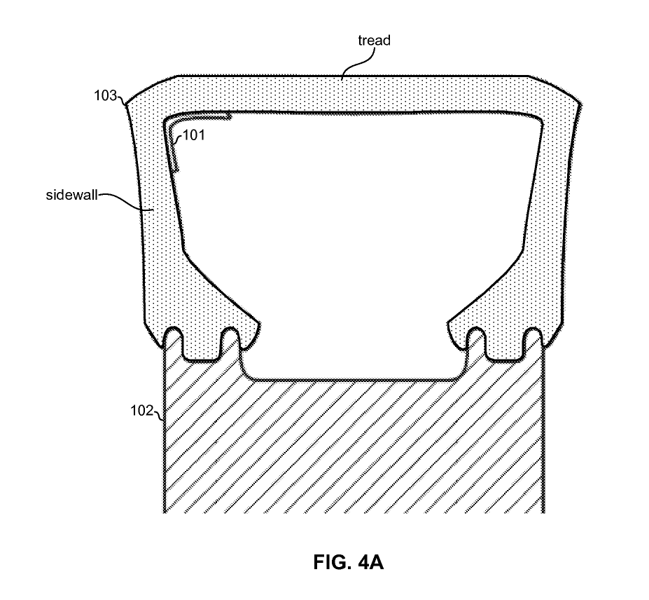

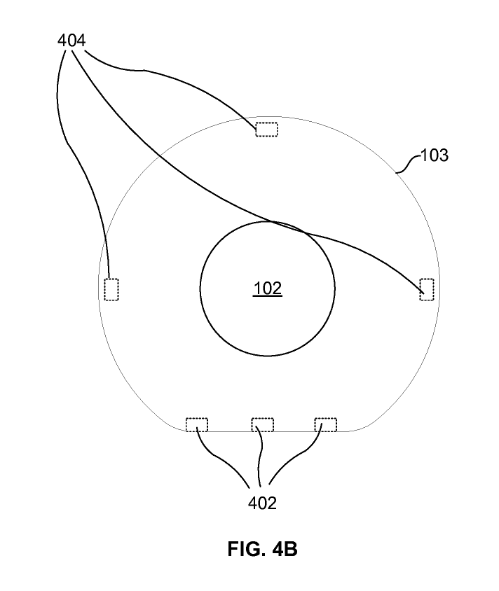

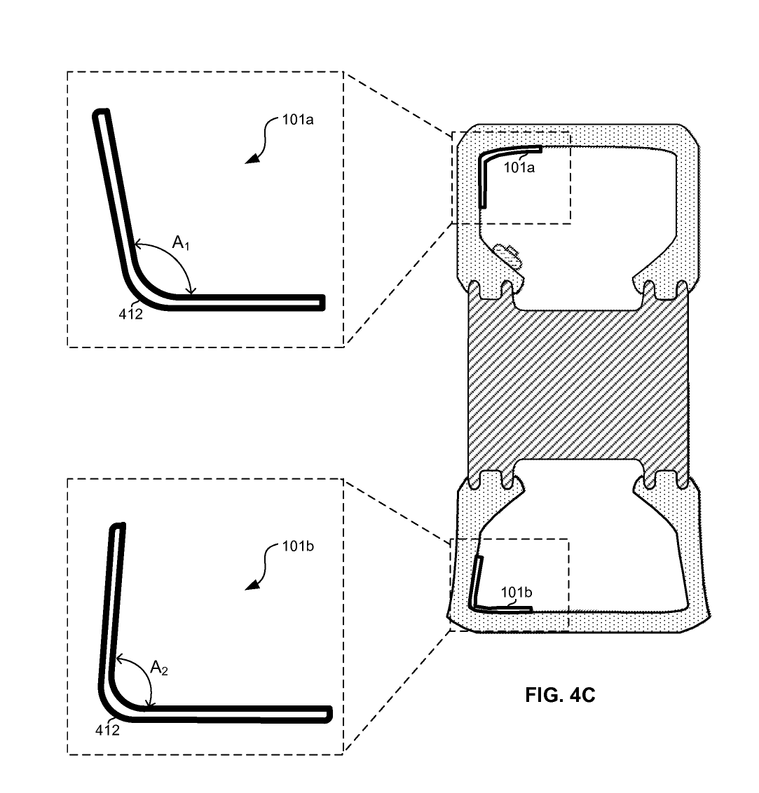

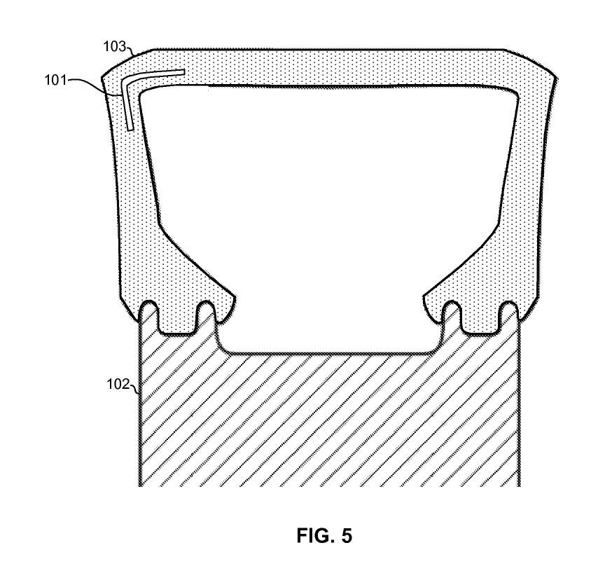

FIG. 4A depicts an exemplary sensor located inside a tire, wherein the sensor is mounted to the tire. Shown in FIG. 4A is a cross-section of a tire 103 and a wheel 102 with a sensor 101 mounted to the inside of the tire 103. The sensor 101 may be as described above with respect to FIG. 2. The sensor 101 depicted in FIG. 4A may be operable to measure the flexion of the tire 103. For example, a flexion sense module may be manufactured out of a low-cost, low-mass film membrane that can be affixed to and/or embedded into (as, for example, shown in FIG. 5) the tire 103. An advantage of this approach is the relative ease of applying equivalent masses to other, well-defined, points of the tire in order to maintain ideal wheel and tire balance. The shape of the membrane may change along with changes to the shape (e.g., the angle between the sidewall and the tread of the tire) of the tire.

In an embodiment of the invention, the flexion sense module derives a calibrated tire pressure by comparing (1) the flexion of tire 103 while being compressed between the wheel 102 and the road to (2) the flexion of tire 103 while not being compressed. For example, referring to FIG. 4B, the flexion while being compressed may be measured at one or more of points 402 and the flexion while not being compressed may be measured at one or more of points 404. The difference between the flexion when under load and when not under load (e.g., the difference between angle A2 and A1 in FIG. 4C) may be used to calculate air pressure in the tire 103. The correlation between air pressure in the tire 103 and the flexion of the tire 103 may be dependent on various parameters such as, for example, the weight of the vehicle 100, the dimensions of the tire 103, and pressure itself. Such parameters may be programmed into the tire pressure management system and compensated for when calculating air pressure. For example, values pertaining to the weight of the vehicle 100, adjusted for each tire, and the dimensions of the tire may be configured into the sensor 101 and/or the access point 104 during installation of the tire pressure management system into the vehicle 100.

While the difference in flexion between loaded and unloaded portions of the tire may be determined by a single sensor 101 making measurements at different times, it may also be determined by multiple sensors 101 in a tire taking measurements at the same time. In other words, sensors 101a and 101b in FIG. 4C could be the same sensor 101 at different points in time or could be two sensors 101 at the same point in time.

Flexion may, for example, correlate to resistance of the membrane, which may change as the shape of the membrane changes. For example, as the angle, A, of the of the membrane decreases from some value less than or equal to 180° toward 0°, the surface 412 of the membrane may stretch, and its resistance may increase. Conversely, as the angle A increases from some value greater than or equal to 0° toward 180°, the surface 412 may compress and its resistance may decrease. Accordingly, measuring the resistance of surface 412 (e.g., by measuring a voltage drop across the surface 412), may enable calculating the angle A which may, in turn, enable calculating the tire pressure.

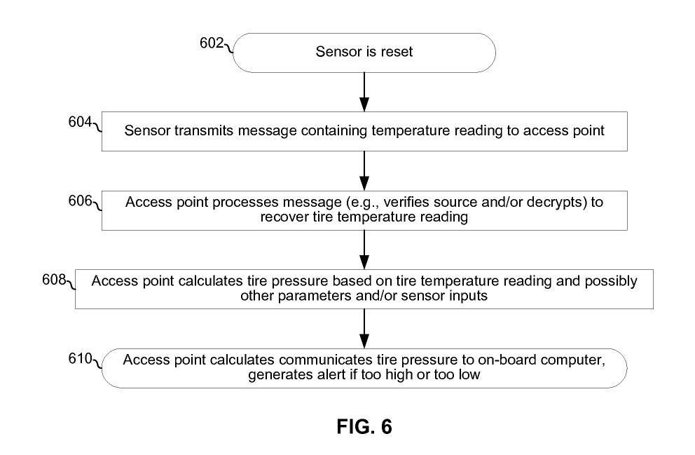

FIG. 6 is a flowchart illustrating exemplary steps for monitoring tire pressure via a temperature sensor located inside a tire. The exemplary steps begin with step 602 in which the tire is properly inflated and sensor 101 is reset. Upon reset, baselines value of one or more parameters (which may be measured and/or determined by the sensor 101 itself and/or other components of the vehicle 100) may be stored.

In step 604, the tire pressure management system may begin normal operation and the sensor 101 may transmit a message containing a temperature measurement to the access point 104. The message may be sent in accordance with, for example, ISO 18000-7 protocols.

In step 606, the access point may process the message to recover the temperature reading. Processing may comprise, for example, verifying the source of the message, decoding the message, and decrypting the message.

In step 608, the access point may calculate the tire pressure based on the received temperature reading. The calculation may utilize the baseline parameter values stored during step 602. Additionally and/or alternatively, the calculation may take into account other parameters such as, for example, past temperature measurements from the sensor 101, temperature measurements from other sensors, historical speed information, etc. The calculated pressure may be an absolute or a relative value.

In step 610, the access point 104 may communicate the tire pressure to an on-board computer. If the tire pressure is outside a permissible range (which may, for example, be preset by maintenance technicians and/or determined during step 602 when the tire pressure monitoring system is reset) then the message communicated to the on-board computer may generate an alert. For example, an in-car audio and/or visual alarm may be triggered and/or an alert may be sent to an external electronic device (e.g., the owner's cell phone) via a wireless signal (e.g., an ISO 18000-7 signal).

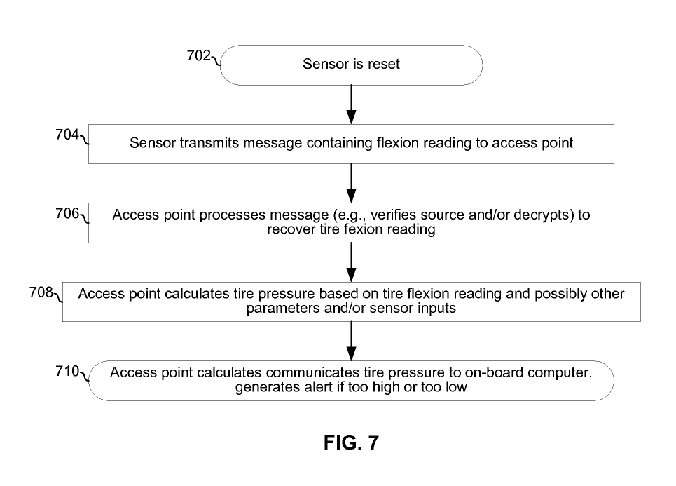

FIG. 7 is a flowchart illustrating exemplary steps for monitoring tire pressure via a flexion sensor located inside a tire. The exemplary steps begin with step 702 in which the tire is properly inflated and sensor 101 is reset. Upon reset, baseline values of one or more parameters (which may be measured and/or determined by the sensor 101 itself and/or other components of the vehicle 100) may be stored.

In step 704, the tire pressure management system may begin normal operation and the sensor 101 may transmit a message containing a temperature measurement to the access point 104. The message may be sent in accordance with, for example, ISO 18000-7 protocols.

In step 706, the access point may process the message to recover the flexion reading. Processing may comprise, for example, verifying the source of the message, decoding the message, and decrypting the message.

In step 708, the access point may calculate the tire pressure based on the received flexion reading. The calculation may utilize the baseline parameter values stored during step 702. Additionally and/or alternatively, the calculation may take into account other parameters such as temperature measurements, speed measurements, etc. The calculated pressure may be an absolute or a relative value.

In step 710, the access point 104 may communicate the tire pressure to an on-board computer. If the tire pressure is outside a permissible range (which may, for example, be preset by maintenance technicians and/or determined during step 702 when the tire pressure monitoring system is reset) then the message communicated to the on-board computer may generate an alert. For example, an in-car audio and/or visual alarm may be triggered and/or an alert may be sent to an external electronic device (e.g., the owner's cell phone) via a wireless signal (e.g., an ISO 18000-7 signal).

In an exemplary embodiment of the invention, a tire pressure monitoring system comprising a sensor 101 located inside a tire 103 of a vehicle 100 may be operable to measure one or both of a temperature inside the tire 103, and flexion of the tire 103. The tire pressure monitoring system may be operable to calculate an air pressure inside the tire 103 based on one or both of the measured temperature and the measured flexion. Communications between the sensor 101 and other components of the tire pressure monitoring system may be via an ISO 18000-7 link. The sensor 101 may be embedded in the tire 103 (e.g., in the sidewall, in the tread, or in the liner). The sensor 101 may measures flexion of the tire 103 at a point 402 (e.g., the point where the tire meets the ground) where the tire 103 is being compressed and at a point 404 (e.g., the point opposite where the tire meets the ground) where the tire 103 is not being compressed.

The air pressure inside the tire 103 may be calculated based on historical speed data of the vehicle which may be provided to the tire pressure monitoring system by an on-board computer of the vehicle 100. The air pressure inside the tire 103 may be calculated based on a temperature external to the tire 103. The external temperature may be measured by a different sensor 101 of the vehicle 100 and provided to the tire pressure monitoring system by the on-board computer. The air pressure inside the tire 103 may be based on one or more dimensions of the tire 103. The sensor 101 may comprise a reset button for initializing one or more parameters utilized by the tire pressure monitoring system. Communications over the ISO 81000-7 link may be encrypted.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for tire pressure monitoring

Accordingly, the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for comprising:
performing by a tire pressure monitoring system comprising a sensor located inside a tire of a vehicle:
measuring, via said sensor, one or both of: a temperature inside said tire, and flexion of said tire; and
calculating an air pressure inside said tire based on one or both of said measured temperature and said measured flexion.

2. The method of claim 1, wherein said sensor is embedded in said tire.

3. The method of claim 1, wherein said sensor measures flexion of said tire at a point where said tire is being compressed and at a point where said tire is not being compressed.

4. The method of claim 1, wherein said sensor measures flexion of said tire at a point of said tire that contacts the ground and at a point opposite said point that contacts the ground.

5. The method of claim 1, wherein said flexion of said tire correlates to a resistance measurement performed by said sensor.

6. The method of claim 1, comprising calculating said air pressure inside said tire based on historical speed of said vehicle and/or a temperature external to said tire.

7. The method of claim 1, comprising calculating said air pressure inside said tire based on one or more dimensions of said tire.

8. The method of claim 1, wherein said sensor comprises a reset button for initializing one or more parameters utilized by said tire pressure monitoring system.

9. The method of claim 1, wherein communications between said sensor and other components of said tire pressure monitoring system are wireless.

10. The method of claim 9, wherein said wireless communications are via an ISO 18000-7 link.

11. An apparatus comprising:
a tire pressure monitoring system comprising a sensor located inside a tire of a vehicle, said tire pressure monitoring system being operable to:
measure one or both of: a temperature inside a tire, and flexion of said tire; and
calculate an air pressure inside said tire based on one or both of said measured temperature and said measured flexion.

12. The apparatus of claim 11, wherein said sensor is embedded in said tire.

13. The apparatus of claim 11, wherein said sensor measures flexion of said tire at a point where said tire is being compressed and at a point where said tire is not being compressed.

14. The apparatus of claim 11, wherein said sensor measures flexion of said tire at a point of said tire that contacts the ground and at a point opposite said point that contacts the ground.

15. The apparatus of claim 11, wherein said flexion of said tire correlates to a resistance measurement performed by said sensor.

16. The apparatus of claim 11, wherein said tire pressure monitoring system is operable to calculate said air pressure inside said tire based on historical speed of said vehicle and/or a temperature external to said tire.

17. The apparatus of claim 11, wherein said tire pressure monitoring system is operable to calculate said air pressure inside said tire based on one or more dimensions of said tire.

18. The apparatus of claim 11, wherein said sensor comprises a reset button for initializing one or more parameters utilized by said tire pressure monitoring system.

19. The apparatus of claim 11, wherein communications between said sensor and other components of said tire pressure monitoring system are wireless.

20. The apparatus of claim 19, wherein said wireless communications are via an ISO 18000-7 link.
